(19) United States
(12) Patent Application Publication
(10) Pub. No.: US 2010/0083949 A1
(43) Pub. Date: Apr. 8, 2010

(54) ENERGY EFFICIENT GRIDDLE PLATE

(76) Inventor: Huang Lee Lisheng, Palo Alto, CA (US)

Correspondence Address: PERKINS COIE LLP, P.O. BOX 1208, SEATTLE, WA, 98111-1208, US

(21) Appl. No.: 12/246,459

(22) Filed: Oct. 6, 2008

(51) Int. Cl. A47J 27/02

(52) U.S. Cl. 126/390.1; 99/422

(57) ABSTRACT

An energy efficient griddle plate is provided that includes a base and a pattern of flame guide channels connected to or constructed on the base. The guide channels can accept flames and guide the flames and heated air to the perimeter of the base while fins extending from the base absorb thermal energy; Linear channel profiles provide a substantial surface area enhancement from a given area on the bottom so as to improve heat transfer while providing even heating and mechanical strength to the plate; A flame entrance opening can be provided in as along as the flame guiding channels to allow easy entrance of the flame into the channels. Further, a burner pattern is given to improve the temperature uniformity on the flat surface of the plate. A method of making the efficient cookware involving extrusion is provided.

### FIELD OF THE INVENTION

The invention relates generally to cookware. More particularly, the invention relates to heat transfer from a heating element to cookware, especially from a flame over a gas range during a cooking process.

### BACKGROUND

Cookware is a basic tool used daily in human life. Regardless of different shapes of cookware, ranging from a stock pot to a wok, to a teapot, cookware can include two basic elements: one for receiving heat from a heat source, and one for heating food. Heat energy generated either from a variety of sources, for example, electricity, or a burning flame. The heat energy is transferred from the source to the heat-receiving surface of the cookware, conducted through the cookware and transferred to food in the cookware.

Heat transfer from combustion sources can be inefficient. The utilization of thermal energy from gas on a typical gas range for heating up cookware is reported to be only about 30%. This means a lot of energy is wasted during the cooking process. As a result, people pay unnecessarily high energy bills and produce unnecessary, undesirable CO₂ into the environment.

For gas ranges, effort has been directed to optimize burners so that there is a good mix of air and fuel gas in order to complete combust the fuel. Attention has also been paid to distribute the heat evenly across the base of a cookware. However with respect to combustion cooking, there has been limited effort made to improving the energy receiving end of the process.

### SUMMARY OF THE INVENTION

A piece of cookware typically has a base and a wall, where the wall extends from the top side of the base and spans a perimeter of the base. In the patent application (App. No. 11/992,972) by present inventor suggests a new type of cookware that has at least one pattern of flame guide channels connected to base of the cookware, where the flame guide channel is made from a pair of guide fins. The guide fins have a flame entrance end near a center region of the base, and have a flame exit end positioned towards the perimeter of the base. At least one pattern of perturbation channels is included, where the perturbation channel is made from a pair of perturbation fins. The perturbation fins have a first perturbation end positioned away from the central region and a second perturbation end positioned towards the cookware perimeter. The flame guide channel accepts a flame from a stove burner and guides it towards the perimeter from the central region. The perturbation fins generate lateral turbulence in the guided flame by interfering with an onset of laminar flow in the flame as the flame moves along the guide channel. The induced turbulence increases heat transfer from the flame to the base and fins, while minimizing mixing of the flame with ambient air. Such induced turbulence promotes conduction of the flame heat through the cookware and to food for more efficient cooking.

In addition to the heat exchange feature in the channels in cookware presented in the application No. 11/992,972, a griddle with heat exchange channels with perturbation features is discussed herein. The enhancements can improve heat transfer from a flame to the griddle plate.

A griddle plate with linear exchange channels can provide efficient heat exchange for a gas flame heating the griddle plate. Linear channels are oriented in the length direction of the griddle plate to have a long heat exchange path to transfer as much thermal energy as possible. In another aspect, the exchange channels spread heat laterally to improve the uniformity of heating of the griddle.

In another aspect, the fins of the channels are designed in such way that the flame entrance impedance is low to facilitate the entrance of flame into the channels.

In another aspect, flame entrance openings are made in the channels to facilitate the entry of flame in the channels to improve heat transfer.

Further, the thickness of the base of an extruded plate implementing the griddle and a related fin thickness and fin height are optimized to sufficiently spread heat to minimize the chance of warping of a large griddle plate. Advantageously, the griddle performs well in heavy use in the harsh environment of a commercial kitchen.

In manufacturing, extrusion is used to draw out the channel plates. In order to construct a large surface, friction stir welding can be used to join two or more extruded channel plates together to form a large griddle plate.

Stainless steel has good properties of corrosion resistance, and is mechanically robust against scratches. As such, an aluminum griddle plate with heat channels can be rolling bonded to a stainless steel surface layer so that top surface will have good corrosive resistance.

An aluminum griddle plate with heat exchange channels can be hard anodized on a cooking surface so that the surface is smooth having a hard anodized sapphire layer which is chemically inert, and provides a layer that can protect against scratches.

### BRIEF DESCRIPTION OF THE FIGURES

Objectives and advantages disclosed herein will be understood by reading the following detailed description in conjunction with the drawing, in which:

FIG. 1 shows a radial pattern of heat exchange channels

FIG. 2 shows a unit of cookware with a linear pattern of heat exchange channels

FIG. 3 shows a piece of cookware having a square base with a linear pattern of channels

FIG. 4.1 shows guide fins with flat tops

FIG. 4.2 shows guide fins with rounded tops

FIG. 5 shows a channel profile which width varies across the base

FIG. 6 shows a unit of cookware with a circular flame entrance opening in the center region

FIG. 7 shows cookware with a rectangular flame entrance opening in the center region

FIG. 8 A griddle plate with linear heat exchange channels

FIG. 9 A griddle plate with linear heat exchange channels having flame entrance openings

FIG. 10 A griddle plate with linear heat exchange channels having flame entrance and exit openings

FIG. 11 A setup for rolling bond/impact bond process

FIG. 12 A griddle plate having a Louver fins structure

FIG. 13 A section view of a steam chamber griddle heat exchange channels

### DETAILED DESCRIPTION

Although the following detailed description contains many specifics for the purpose of illustration, anyone of ordinary skill in the art will readily appreciate that many variations and alterations may be made.

In a typical process, a piece of cookware holding a medium such as water is placed on top of a flame from a burner; The flame rises up due to pressure of the gas in the supply piping and the buoyancy of the hot air causes it to touch the base of the cookware. Heat is transferred from the flame to the base via convection transfer as well as radiation transfer. The heat is absorbed from the heat-receiving surface and is transferred to the food surface by thermal conduction. Heat is then transferred from the food surface to the water via conduction and convection. In this whole process, the heat transfer from the flame to the cookware body via convection transfer is the most inefficient step limited by the thick boundary layer of the flame flow, while the heat transfer from the cookware the content is the next inefficient also limited by boundary layer of the liquid content. The heat conduction inside the body of the piece of cookware is efficient where the cookware is constructed of metal.

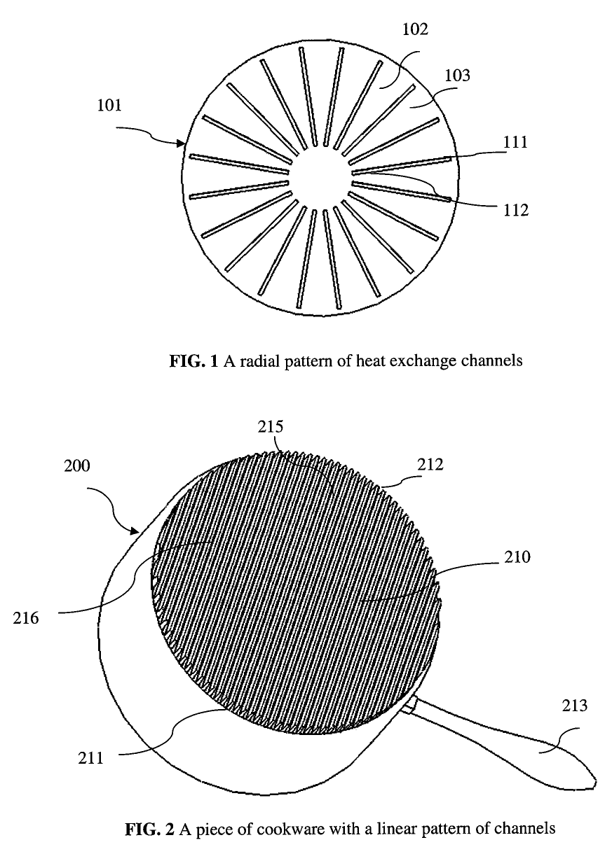

Heat exchange channels are proposed by current inventor to improve the heat transfer efficiency. A radial heat exchange channel pattern described in U.S. patent application Ser. No. 11/992,972 is shown in FIG. 1. This is the bottom view of piece of cookware 101. There is a pattern of channels formed by fins protruding upward from the base of the piece of cookware 101. As used herein a “channel” is defined as the space in between a pair of fins and the base along the direction of the fins. For example, fins 102 and 103 form a channel in the space between them. The ratio between the height of the fins and the distance between the fins is larger than one to have a recognizable channel guiding heat exchange effect to be considered a guiding channel. In the radial pattern in FIG. 1, the channel width will change along the path. As indicated in FIG. 1, the width of the channel at location 111 is larger than that in location 112 which is closer to the center of the radial pattern. However, for any given manufacturing method, there is limit on smallest dimensions, such as gaps and fin width. This determines the surface area enhancement the exchange channels over a flat surface can be achieved. It will be preferable to have channel width across the whole base to be at the minimum dimensions allowed by the manufacturing process. Therefore a radial pattern with varying widths makes it difficult to utilize the maximum surface area improvement that a given manufacturing process can provide.

In a linear pattern heat sink structure, on the other hand, the channel spacing can be constant. Therefore it is possible to make channels across the whole base of the piece of cookware using the smallest dimension a given manufacturing process can produce. This linear pattern can create the most surface area improvement in a channel format over the original flat surface for a given size of the flat surface area.

A piece of cookware with linear pattern heat exchange channels is shown in FIG. 2, in this case, a pot. The piece of cookware 200 includes a linear pattern of channels 210. The channel width is constant along the length of the channels. A typical flame from a burner will be placed close to the center region of the cookware. Once the flame enters the channel, the flame will be guided to flow towards the perimeter of the base of the piece of cookware. Eventually the flame exits the channel at the perimeter indicated by 211 and 212. As the flame flows in the channels, heat is transferred from the flame to the base and the fins. The material of the fins can have a high thermal conductivity coefficient; therefore heat absorbed by the fin can be conducted to the base easily to help the overall heat transfer from the flame to the food inside the cookware. This can be viewed as an increase of heat exchange surface area effectively for the energy to transfer from hot flame to the body of the cookware. Also seen in FIG. 2, a handle 213 extends from the wall at locations away from the output of channels, in this example perpendicular to the output. Advantageously, the handle will not be heated by flames escaping from the channels. This improvement can reduce the risk of a burned hand.

Advantageously, there is a substantial improvement over conventional cookware when using a linear channel pattern with a plain surface. For example, consider a piece of aluminum cookware having guide fins which have a width of 0.08 inch, a gap of 0.15 inch and a height of 0.5 inch. This exemplary piece reduced cooking time by about 50% as compared with a similarly size conventional piece of cookware without the exchange channels. The decrease in cooking time of the improved cookware significantly improves energy utilization in cooking over a gas range.

Another example follows. It is also found in experiments that the use of cookware having an 8 inch square base with heat transfer channels over an 8 inch square base piece of cookware without heat transfer channels is about 10% larger than the improvement from an 8 inch round base cookware with the same heat transfer channels over a round base cookware without the heat transfer channels. The channel design in both cases is the same: width of the channel is 0.15 inch, the fin width is 0.08 inch and the height is 0.5 inch. This result indicates that the extra channel length at the corner of the square base cookware confine the flame for heat exchange while in the round base cookware the channels at the perimeter of the base run off quickly. Since the heat exchange happens inside the exchange channel, the extra channel length at the corners is what makes the difference. This effect can be significant on a range which fuel speed is fast therefore the complete combustion of the fuel may happen at a distance from the exit of the fuel gas from the burner. To make a square based cookware to have a normal round cookware look, a design of the square base cookware can have a round top opening.

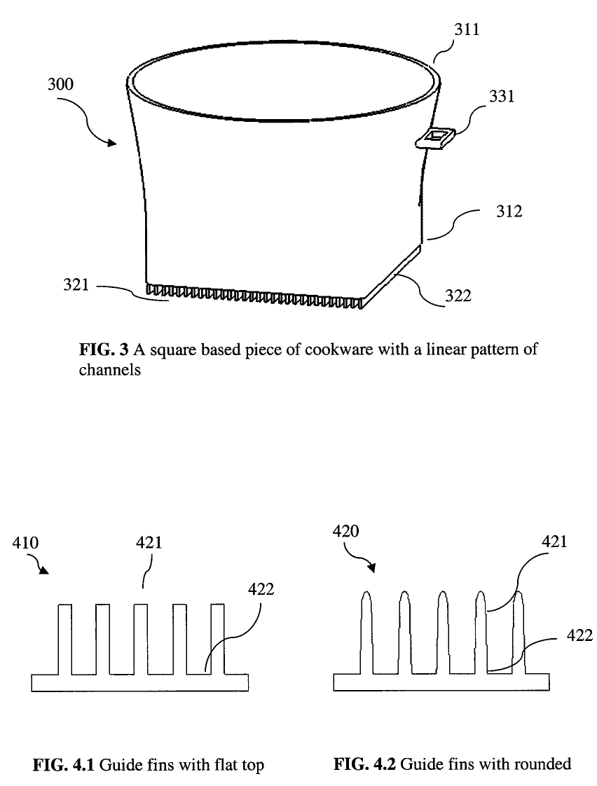

FIG. 3 depicts an exemplary piece of cookware 300. The piece of cookware 300 has a wall that is circular at the top 311, but squared at the bottom 312. This can be done by using a standard progressive deep draw manufacturing process. The exchange channels 321 are built to be in parallel to one of the edge 322 of the square base. This use of parallel channels will give extra channel space in the corners of the base to transfer thermal energy. A handle 331 is attached on the wall in area above the edge 322 which the heat exchange channels are made parallel to. Since hot flame is guided to flow along the direction of the edge 322, the handle 331 will be less likely to be heated by the flame.

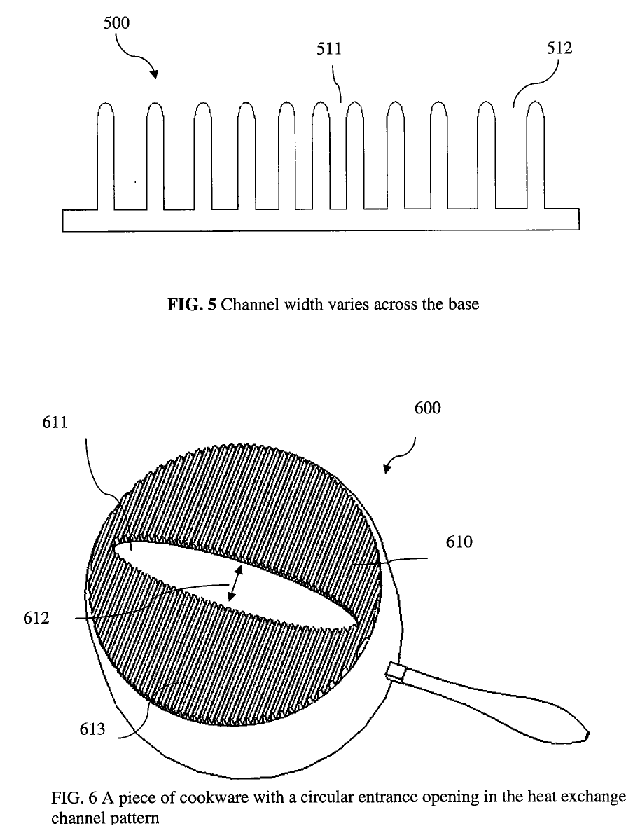

To have efficient heat exchange in the channels, hot flame must be allowed to flow into channels freely without too much impedance. It is found in that this requirement need to be balanced with the need of enhancement of surface area. To have a large surface area enhancement, it can be desirable to have dense fins which lead to thinner fins and therefore narrower channel widths. However if the width of the channel is too narrow, the density can limit the ability of hot flames to enter into the channels. The ratio between the thickness of the fin at the entrance ω_{f}, and the width of the channels ω_{c} is defined as the impedance Ωₑ to the flame entrance to the channels, Ωₑ=ω_{f}/ω_{c}. To reduce the flame entrance impedance, the thickness of the fin should be small. However, when the fin is too thin it will be more easily damaged during daily use in a commercial kitchen; even the heat transfer efficiency from the height of the fins to the base can be comprised. So it will be preferable to reduce the impedance while retaining the strength of the fins. One way to reduce the impedance is to sharpen the top of the fins by rounding and tapering. FIG. 4.1 shows a fin structure 410 where the fin width is denoted as 411 and the channel width is 412. A typical fin top is flat; the impedance of the air can be represented by the ratio of fin width 411 over channel width 412. As shown in the FIG. 4.2 the top of the fins in fin structure 420 are rounded up. The top of the fins is smaller making the effective width of the fin smaller therefore reducing the impedance to hot flame when it enters to the channels. Also see in the figure, the thickness of the fin at the top end 421 is smaller than the thickness of the fins 422 at the base. This rounded tapered fin reduces the flame entrance impedance therefore improving the heat transfer efficiency

The flame flow entrance impedance to the channels plays an important role in the efficiency of the cookware. In an experiment, a piece of cookware with guide fins width of 0.08 inch, gap of 0.1 inch and height of 0.5 inch was tested. This channel fin density is higher than the one with guide fins width of 0.08 inch, gap of 0.15 inch and height of 0.5 inch described in the example in the previous example, therefore efficiency was expected to be higher from the surface area point of view. However the efficiency dropped by 10% from the design described above which results in 50%. This is because entrance impedance of the flame flow to the channel this one is 0.8 compared with 0.53 for the previous one.

The higher flow entrance impedance makes the efficiency lower even the surface area is larger. By cutting 3 slots of 0.25 inch across the channels in the center region to facilitate the entrance of the flame does set the efficiency back by 5%. This illustrates the importance of reducing the flame entrance impedance. The cutting of the slots helps the flame to get in to the channel. So it is important to reduce the entrance impedance for efficient heat exchange.

Besides the impedance, the entrance of a flame to channels is also affected by the direction of the flame flow with respect to the direction of the channels. A typical burner generates a symmetric central flame flow. As the flame flows upward due to buoyancy into the channels, it also flows outward in a radial direction. For the piece of cookware shown in FIG. 2, as the flame goes outwards, the outward flow velocity in region 215 is in general the direction of the channels. The flow can enter into channels easily, and therefore the channel density can be made higher. On the other hand, in region of 216, the flow velocity has a large component in perpendicular to the direction of the channels. It is preferable to have the width of the channels to be larger in this region to allow the flow to enter the channels easier. FIG. 5 shows a channel pattern 500 where the channel width varies across the base. The channels in region 501 are in the same general direction of the flame flow, the channels width can be narrower to have denser fins therefore bigger surface area improvement. While in the region 502, the flame's radial flow has a large velocity component running perpendicular to the direction of the channels. Therefore it is preferable to have wider channels in this region to allow easier entrance of the flame flow into the channels. Different range burners from different vendors will have different flame flow profiles and temperature distributions. Therefore the variation in channel width should be optimized accordingly for different ranges.

A flame entrance opening can be made in the channels can help a flame enter the channels. An entrance opening is an area of the base where the height of the fins is zero or is substantially lower than the height of the other fins. For example a circular area in the center of a base can be made such that there are no fins. The size of the area can match the size of a flame from a burner. The flame can exit from a burner, rises up due to buoyancy force to entrance opening and bonded by the base inside the entrance opening. The hot flame has to go into the channels to continue to flow, and can escape from the perimeter of the base. Therefore via the entrance opening, flame can have complete entrance into the channels resulting improved efficiency. Typical burner flame patterns on the market are circular and donut shapes, however, it can be suitable to have the entrance opening be a circle or an elongated circle or even an ellipse.

An energy efficient piece of cookware having an elliptical entrance opening in the channels is shown in FIG. 6, in this case, a pot. The piece of cookware 600 has exchange channel pattern 610, and there is an elliptical entrance opening 611 in the center region of the base of the piece of cookware 600. This elliptical opening is in general matched with the conventional range flame pattern. The short axis 612 of the elliptical shape is in the direction of the channels 610. Hot flame that gets into the entrance opening has to come out through the channels to the perimeter of the base. However, due to the opening, the length of the channels in region 613 is reduced somewhat compared to otherwise without opening.

To preserve the length of the linear channels for effective heat exchange, a rectangular entrance opening can also be used. A rectangular entrance opening can be made in the center region of the channel pattern, which will be oriented such that the length direction of the rectangle transverses the direction of the channels. This rectangular flame entrance opening in the channel fins allow the flow to enter to the channel efficiently.

A piece of cookware having a rectangular flame entrance opening is shown in FIG. 7. The heat exchange channels pattern is linear, and there is an area 711 in the center region that does not have fins. In this area, the flame flow is directed to enter channels and then flow away from the base. The length of the exchange channels in area 712 is not affected by the rectangular entrance opening as much as by a circular or elliptical entrance opening as seen in FIG. 6. This pattern is especially suitable for square based cookware.

The above design principle for improving the cookware efficiency can be readily applied to a gas griddle plate. A griddle plate can be used over a gas range. Alternatively, a griddle can be an appliance that stands alone as an important piece of equipment in a kitchen in the foodservice industry.

A typical gas griddle uses a hot rolled or cold rolled steel plate with a gas burner disposed below the plate. The distance between the burner and the plate is optimized for the complete combustion of fuel and transfer of heat from the resultant flame to the griddle pate. A temperature sensor can be attached to the griddle plate. The temperature of the griddle plate can be controlled manually or by automatic control circuits. A typical shape for a griddle plate is rectangular, although when a flame exits the burner the flame can easily move to the wide side of the long edge of the plate. This is because the long edge of the rectangular plate is typically located near the flame outlet. When a flame flows along a large flat plate, it will tend to form a laminar flow which is not favorable to the heat exchange between the flow and the plate due to development of a thick boundary layer. One way to improve this is to introduce heat exchange channels that have features to improve the interaction between flame and the plate. Such is enhanced by using a feature that will disturb the formation of the laminar flow.

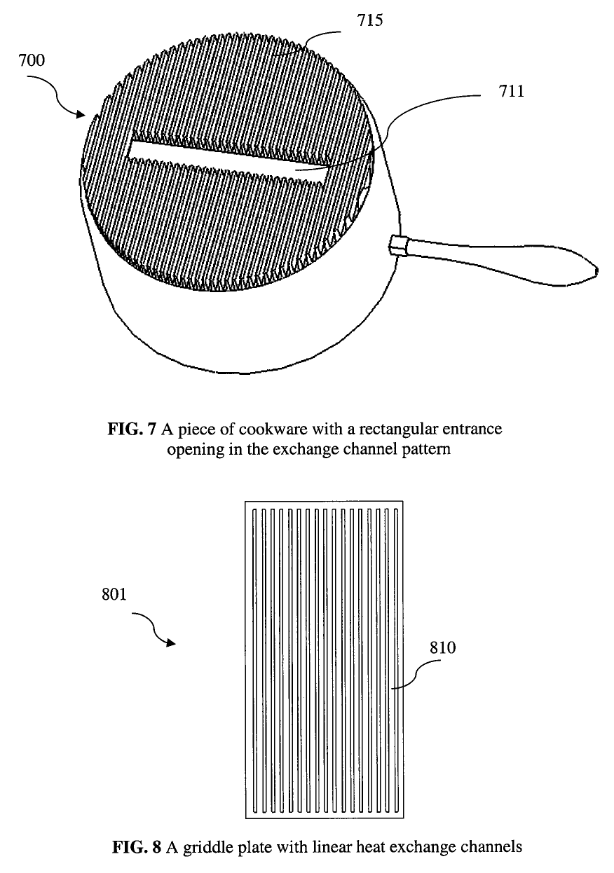

To improve the efficiency, a linear channel pattern can be made on the base of the griddle plate, i.e. the heat receiving surface of the griddle plate. The arrangement of the channel can be such that the channel is running along the direction of the long edge of a griddle plate. Therefore the exchange channel can have the longest available interaction length. An exemplary unit is seen in FIG. 8. There, the bottom view of a griddle plate 801 is depicted where the channels 810 run in the direction of the longer edge 802 of the plate.

To improve flame entrance into the channels provided for a piece of cookware, flame entrances can be placed along the path of the channels as shown in FIG. 9. Griddle plate 901 has channels 910 running along the long side of the plate. There are flame entrance openings 920 along the path of the channels. The shape of the flame entrances opening 920 is rectangular, or linear oriented in the direction of transverse the direction of the channels 910.

In conjunction with the griddle plate, there can be a pattern of burners along the path of the channels disposed corresponding to the flame entrance openings. For a case of the front edge 903, the flow of the flame will be guided along the channels and exit from the edge of the plate 904. The space between the burners and the Btu number of the burners is well matched such that there will be as uniform a temperature as possible on the griddle plate. The flame entrance openings maximize flame entry into the channels, and the linearity of the exchange channel can simplify the design of the burner profile, i.e. placement of the burners along the channel path and the Btu numbers of the burners by using one dimension simulation.

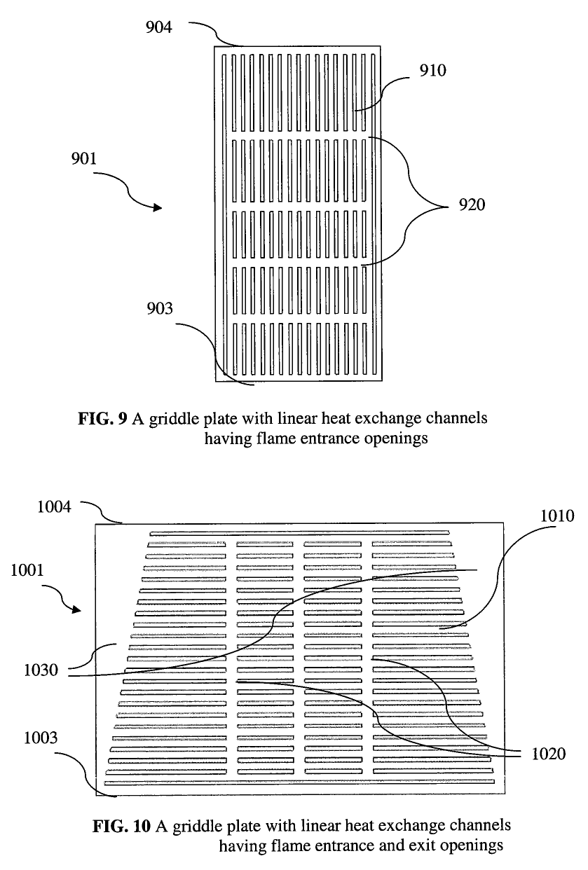

A bottom view of a griddle plate is shown in FIG. 10, where the griddle plate 1001 has a long edge 1003 along the front of the griddle. Typically the flame exit is at the back edge 1004 of the griddle. As usual, the linear exchange channels 1020 will run along the long edge of the griddle plate. Flame entrance openings 1030 are spaced along the length of the channel 1020. When the flame is guided from the center portion of the griddle to the edge, the flame will exit. In order to allow the flame to exit from the end of the channel to the back edge 1004 of the griddle, there can be a space 1040 where the channels are terminated so that the flame can turn to the back edge of the griddle to exit. The shape of the termination, i.e. the open area 1040 in the end of the channels can be designed as a first order approximation using a triangle shape with the opening to the back edge.

The linear channel fin not only helps the heat to transfer upward to the plate, it also helps spread the heat across the griddle plate evenly distributing the temperature.

The channel fins reinforce the griddle plate and as such the plate can be constructed without using as much material as a solid plate but can have the same kind of mechanical strength as a solid plate. The thickness of the griddle plate can be optimized, in conjunction with the channel fin design according to the requirements of temperature uniformity, mechanical strength to prevent warping, and minimum use of material. The result is a light weight, high thermal efficient and mechanical robust griddle plate.

The extrusion process can be used to fabricate the heat exchange channels on the griddle plate. The extrusion process is a low cost mass manufacturing process that is used to generate a large volume of aluminum for various applications in various industries, for example, construction and transportation. A griddle plate can be extruded as a whole, for example of 36 inches in width. However a typical extrusion size can vary, for example, of 15 inches in width. To form a large size griddle plate from smaller extruded plates, it can be possible to use friction stir welding to attach two pieces of extruded plate along an edge in the direction of the channels. Together these will form a larger heat sink plate. An advantage of friction stir welding is that the process bonds two pieces together without a large heat affected zone in the metal. Therefore the process preserves the integrity of the material, reducing the chance of weak or fatigued regions in the welded joint.

Machining can be performed to create a pattern of flame entrance openings in the channel fins along the channels. These openings can facilitate the flow of flame into the channels. In the case that the front of the griddle is the long edge, there can be an area at ends of the channels that is machined off to allow the flow to turn to exit at the exit edge.

As a finishing step the top can be milled, and a flat surface of the griddle created such that the flatness of the griddle will meet the requirements for commercial use. It is also possible to polish the surface to reduce the surface emissivity to reduce loss of heat radiated directly from the surface of the plate. Naturally the emissivity of aluminum is 0.03, lower than that of the steel alloys which is at 0.4, therefore by using aluminum will reduce energy lost due to the radiation from the surface as compared most of steel products on the market.

After machining, the griddle plate can be hard anodized. With 4 time of the hardness as compared with normal aluminum, the hard anodize layer provides protection to the plate against physical abuse, such as may be experienced in commercial kitchens. The oxide layer is also chemical inert so as to withstand corrosion. However the thermal conductivity of the layer is poor, and it is therefore preferable to just hard anodize the flat surface without anodizing the heat channel side. Instead, the face with heat exchange channels is roughened using sand blasting, and the roughening of the surface will improve the convention heat transfer, and at the same time increase the surface emissivity to improve the radiation absorption, and therefore further improve the efficiency. The heat channels surface can even be coating with some IR absorption coating to improve heat radiation absorption.

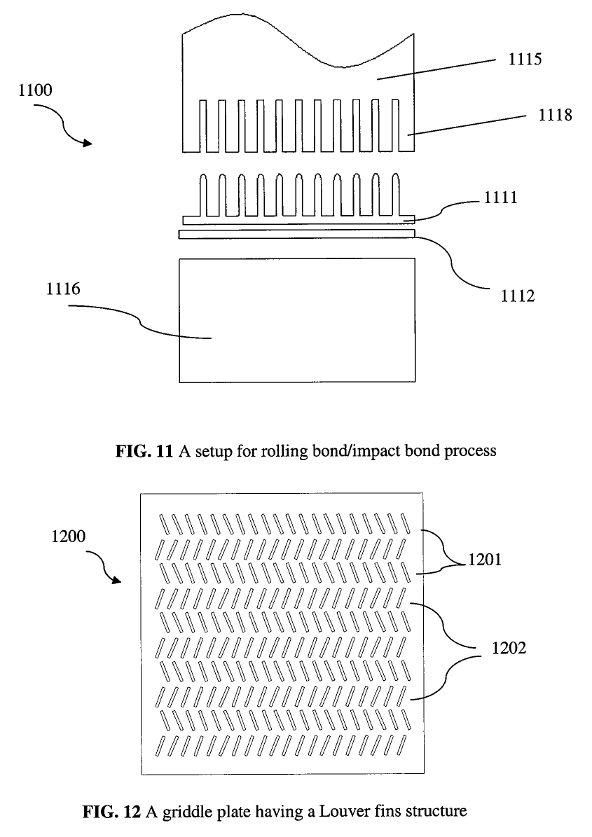

Stainless steel has very good corrosion resistance. As an alternative to anodizing the cooking surface, it is possible to bond a stainless steel surface to an aluminum griddle plate having heat exchange channels. The heat exchange channels are linear, therefore it is possible to rolling bond the extruded aluminum plate to a stainless steel plate. A rolling bond process is depicted in FIG. 11. In this process the extruded aluminum plate 1111 is placed on top of the stainless steel plate 1112, and the stacked aluminum plate 1111 and stainless steel plate 1112 can be heated, for example, to 400 C in an oven or furnace. The environment can be an oxygen reduced environment. After the stack reaches a uniform temperature of, for example, 400 C, the stack can be moved to a rolling mill. In a rolling mill there can be two rollers, roller 1115 and roller 1116. The top roller 115 of the rolling mill can have a complimentary groove 1118 matched to the extruded channels fins 1113. The fins in the extruded aluminum plate can be aligned to the grooves on the roller. Then the stack can be bonded by roll pressing the aluminum plate 1111 and the stainless steel plate 1112 together. It may take couple of rolling runs to reach a desirable bonding strength. The bonded stack can then be heated to a higher temperature, for example, of 450 C for a duration of time sufficient to create a diffusion bond, for example 30 min. The stack can then be cooled down from the high temperature to slowly reduce the amount of the stress built in the stack between the stainless steel plate 1112 and the aluminum plate 1113.

It is also possible to put brazing filler material, for example KAFL (potassium fluoaluminate), between the plates, and the process can combine the advantages of pressure rolling and the high temperature brazing to form a good join.

After the plate is formed, the bonded plate is then water jet cut to a size needed for a specific griddle appliance. Machining can be performed to produce a flame opening in the channels to effectively allow the flame into the channels. The location pattern of the flame entrances is optimized for uniform temperature profile on the griddle surface. Also the exit opening may be machined depending on the design of the griddle, as discussed above.

The griddle as an appliance is fixed in place during use, whereas pieces of cookware on a range are typically moved around. Therefore, it can be possible to braze the features on the heat absorbing surface of the griddle plate such as the metal fins in other patterns. For example, a louver pattern can be used. In FIG. 12, the bottom face of the griddle plate 1200 is shown. The fins array 1201 is brazed on the surface of the plate. Change of direction of the fins 1201 and 1202 forces the flow of the hot air to wiggle around to improve the heat exchange efficiency. The separation between the arrays of fins with different directions will lead to an increase in turbulence that will further improve the heat exchange. Other patterns can also be used, for example, wavy and blunt posts. The goal is to improve the surface area for the interaction of the hot flame with the surface of the griddle.

The surface of a griddle having heat exchange channels can be roughened with sand blasting. The roughening of the surface can help with convection heat exchange, and at the same time the roughening can increase the emissivity of the material to improve the radiation absorption from the radiant heat.

Once the griddle plate is made, the griddle can be installed over a gas burner array which is installed in an appliance frame. Preferably the flame lines are perpendicular to the channel directions so as to direct the flames into the channels. The locations of the flame ports are designed corresponding to the locations of the flame entrance locations. The griddle plate can then be mounted to the frame or chassis of the griddle, for example, by a ceramic ring so that when heat is applied, the heat in the griddle plate will not easily be conducted out to the frame or chassis. This will preserve the energy in the griddle plate. Usually, splash guard plates also are mounted on the griddle plate via welding. A temperature sensor can be placed on the griddle plate as well. This sensor can give temperature feedback to a gas control circuit to regulate an amount of the gas that is used, thereby controlling the temperature of the plate.

Alternatively, as seen in a steam chamber griddle, a chamber of liquid is heated up to a high temperature to produce steam. The top plate of the chamber is a cooking surface of the griddle. The steam inside the chamber can provide uniform heat to the griddle surface and can provide accurate temperature control. This kind of griddle can be viewed as a huge sealed pot. The working principle is like a liquid heat pipe where liquid on one side absorbs heat from a source at the bottom of the chamber and evaporates steam to further carry out latent heat. The steam vapor will come to the cold side, which is the griddle plate side to release the heat to the griddle plate. Once steam releases the heat, it cools down and transitions back to liquid, further releasing the latent heat to the griddle plate. The liquid can then drip back into the hot bottom of the chamber. The cycle continues.

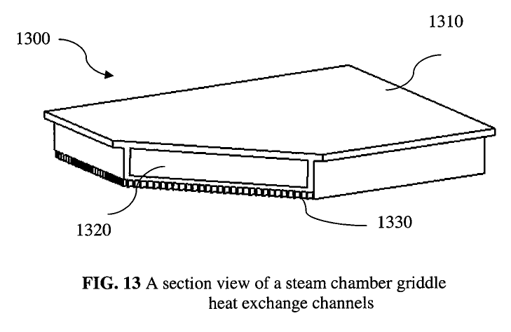

Using a similar approach to that described above, an improvement can be achieved by implementing heat exchange channels on the bottom surface of the steam griddle chamber to help transfer heat from a gas combustion source to the bottom plate of the steam chamber griddle. One example of the steam chamber griddle is shown in FIG. 13. Steam chamber griddle 1300 has a griddle surface 1310, under which there is a chamber 1320, where some working fluid such as water can be stored. To work well with the gas combustion source, a heat exchange channel pattern 1330 is implemented on the bottom of the chamber. The heat exchange channels improve the heat transfer from the flame to the chamber body. To improve the boiling, and therefore the heat transfer, a boiling enhancement plate can be put inside the chamber. The working principle of the boiling enhancement plate is described in patent application Ser. No. 11/992,972. Basically it will help create permanent nucleation sites to facilitate boiling to occur. The heat transfer rate is higher than just conduction. Heat transfer using steam involves a phase transition that involves transfer of a large amount of latent heat. This boiling enhancement plate will be fixed inside the chamber against the bottom plate (not shown). Combining the heat exchange channels on the outside surface of the chamber with the boiling enhancement plate inside the chamber can dramatically improve the energy efficiency of the steam chamber griddle. Alternatively, a fin pattern can also be implemented on both surfaces of the bottom plate of the steam chamber to improve the heat exchange from combustion flame to the bottom plate and from bottom plate to the liquid inside.

It will be appreciated to those skilled in the art that the preceding examples and are exemplary and not limiting. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

We claim:

1. A griddle plate comprising:
a. a flat metal plate, having two surfaces parallel to each other, a heating surface for receiving heat and a cooking surface for providing the heat to food; said heating surface including a pattern of flame guiding channels defined by guide fins extending perpendicularly below said heating surface;
b. wherein, in operation, heat is generated below the flat metal plate applying the heat to the heating surface of the flat metal plate, said fins guiding the hot air to travel along said flame guiding channels and said fins absorbing the heat; said fins transferring the heat along said guide fins for even distribution of heat, and said guide fins transferring the heat to said cooking surface for heating the food.

2. The griddle plate of claim 1, wherein said guide fins of said flame guiding channels have a height larger than the distance between them.

3. The griddle plate of claim 1, wherein the flame entrance impedance to said flame guiding channel is less than 0.8.

4. The griddle plate of claim 1, further comprising a flame entrance opening in said flame guiding channels.

5. The griddle plate of claim 1, wherein the thickness of said fins is tapered along the height from thicker at a base to thinner at a top.

6. The griddle plate of claim 1, wherein said griddle plate is formed of extruded aluminum.

7. The griddle plate of claim 1, wherein said cooking surface is hard anodized.

8. The griddle plate of claim 1 further comprising: a stainless sheet bonded to said cooking surface of said plate.

9. A system comprising:
a. a flat metal plate, having two surfaces parallel to each other, a heating surface for receiving heat and a cooking surface for providing the heat to food; said heating surface including a linear pattern of flame guiding channels defined by guide fins extending vertically below said heating surface;
b. a gas burner having a pattern of fuel ports distributed to provide fuel, the fuel to be burned to heat said griddle plate;
c. wherein operation, the heat is applied to said plate by said gas burner, heated air flows in said guiding channels to be absorbed by said guide fins efficiently; said guide fins transferring the heat along the guide fins for even heat distribution and for transfer to said cooking surface for heating the food; and
d. a control device to modify the temperature of said flat metal plate by measuring the temperature of said plate and to control the burn rate of fuel of said gas burner.

10. The system of claim 9, wherein said plate has flame entrance openings matched to said pattern of the fuel ports of said gas burner.

11. A chamber griddle comprising
a. a rectangular metal chamber having a top surface serving as a griddle plate; wherein the chamber is filled with liquid; and
b. a heat receiving surface having a pattern of guide fins extending therefrom to define a linear pattern of flame guiding channels, the guide fins operable to receive heat and to provide the heat to the chamber.

12. A chamber griddle of claim 11, where a boiling enhancement plate is inserted in said chamber to enhance boiling heat transfer to said liquid.

13. A chamber griddle of claim 11, where a fin pattern extended inside the chamber from the bottom plate to enhance heat transfer to said liquid.

14. A system comprising:
a. a rectangular metal chamber having a top surface serving as a griddle plate; wherein said chamber is filled with liquid;
b. a heating surface having a pattern of guide fins extending therefrom to define a linear pattern of flame guiding channels, the guide fins operable to receive heat and provide the heat to the chamber;
c. a gas burner having a pattern of fuel ports to provide fuel to burn to heat up said chamber griddle; wherein said fuel ports are matched to said guide channels so as to receive the heat and raise the temperature of the metal chamber; and
d. an electronic control to moderate the temperature of said plate by measuring the temperature of said griddle plate and to control the burn rate of said gas burner.

15. The system of claim 14, wherein said channel pattern of said chamber griddle has flame entrance openings matched to said pattern of the fuel ports of said gas burner.
